(19) United States
(12) Patent Application Publication
(10) Pub. No.: US 2014/0279621 A1
(43) Pub. Date: Sep. 18, 2014

(54) Method, A System and a Computer Program Product for Scoring a Profile in Social Networking System

(71) Applicant: Donna Lynne Otzenberger Kivirauma, Kangasala As (FI)

(72) Inventor: Donna Lynne Otzenberger Kivirauma, Kangasala As (FI)

(73) Assignee: TEAMUP OY, Tampere (FI)

(21) Appl. No.: 13/926,144

(22) Filed: Jun. 25, 2013

Related U.S. Application Data
(63) Continuation-in-part of application No. 13/833,209, filed on Mar. 15, 2013.
Application No. 13/833,209 is a continuation-in-part of application No. 13/832,890, filed on Mar. 15, 2013.

(51) Int. Cl. G06Q 50/00; G06Q 30/02

(52) U.S. Cl. CPC G06Q 50/01; G06Q 30/0282
USPC 705/319

(57) ABSTRACT

A method, system and a computer program product for scoring a profile in a social networking system. The method comprises at least one Fan profile, at least one Talent profile and at least one Business profile, comprising a computer that has access to the social networking system. The computer is configured to receive information of the at least one supporting action to at least one Talent profile a first Business profile has introduced to the social networking system; receive information of the at least one Talent profile which the Fan profile is assigned to; match the first Business profile that has supported the at least one Talent profile and the at least one Talent profile which the Fan profile is assigned to; and calculate based upon the information of at least one supporting action the score metrics representing the first Business profile's influence for the Fan profile.

### PRIORITY CLAIM

This application is a continuation-in-part of U.S. patent application Ser. No. 13/833,209, filed on Mar. 15, 2013 and U.S. patent application Ser. No. 13/832,890, filed on Mar. 15, 2013, both of which are hereby incorporated by reference in their entirety.

### FIELD OF THE INVENTION

The invention relates to social networking systems. More specifically, the invention relates to scoring a profile in a social networking system, where Fans, Talents and Businesses have interconnected profiles.

### BACKGROUND OF THE INVENTION

Current social networking systems enable Businesses to communicate with Talents that they are sponsoring or with Fans of the Talent. The problem with social media or social networks is that the Fan cannot know the totality of the Business' support of the Talents that interest or are important to the fan. Examples of Talents are athletes, artists, musicians, sports clubs, festivals or similar entities, looking for sponsorship. When the Business sponsors a Talent the Fans of the Talent cannot know where that Business or the related Brand ranks among other brands in sponsoring or supporting the talents that they are a fan of. The owner or user of the Fan profile is interested to see how each of the Brands rank in the number of talents they support that the fan has indicated he/she is a fan of.

One solution according to prior art is Facebook, where a Talent and a Business can set up a page. The Business and the Talent can indicate that they are in a sponsorship relationship. These pages are separate and do not highlight the value or the duration of the sponsorship. A fan would have to do extensive research to discover if a Brand is sponsoring other talents that the fan is a fan of. In many cases it is not even told anywhere.

Another known solution is that Brands or Businesses publish a list of the talents that they sponsor on their own website or the information is given on the website of a talent. Again it would take extensive research by a fan to determine if this Brand is sponsoring other Talents he/she is interested in. It is difficult for a Fan to know if a Brand is sponsoring or supporting other Talents he/she is interested in besides the one he/she has found on a website or in Facebook.

### PURPOSE OF THE INVENTION

The purpose of the invention is to score a social network profile, more specifically a Business profile in relation to a Fan profile.

### SUMMARY

The invention indicates how to score and subsequently rank a Business profile based upon the number of Talent profiles that the Business profile is sponsoring or supporting. The invention discloses a method for scoring a Business profile in a social networking system comprising at least one Fan profile, at least one Talent profile and at least one Business profile. The system comprises a computer that has access to the social networking system and is configured to receive information of the at least one supporting action to at least one Talent profile a first Business profile has introduced to the social networking system; receive information of the at least one Talent profile which the Fan profile is assigned to; match the first Business profile that has supported the at least one Talent profile and the at least one Talent profile which the Fan profile is assigned to; and calculate based upon the information of at least one supporting action the score metrics representing the first Business profile's influence for the Fan profile. According to one embodiment the computer is configured to rank the at least one Business profile based on the score metrics in relation to the Fan profile.

According to one embodiment the information of the supporting action comprises the number of the first Business profile's purchases from the at least one Talent profile's shop. Examples of Business profile's purchases include sponsorship packets or similar items that are suitable to be registered in the social networking system. The registration may be initiated by a clickable button within the Talent profile's shop and further registered in the database. According to one embodiment the information of the supporting action comprises the value of the first Business profile's purchases from the at least one Talent profile's shop. The value is for example the monetary value of the sponsorship packet.

According to one embodiment the information of the supporting action comprises the time elapsed from the purchase the first Business profile has completed from the at least one Talent profile's shop. According to one embodiment the infatuation of preceding supporting action is removed from the social networking system after a predetermined time period when the first Business profile is not executing a supporting action. The supporting action of the Business profile may be valued higher if it has been done early during the Talent profile's career. Early supporters may benefit more and they have also an incentive to support emerging Talent profiles. If the support to the Talent discontinues, the social network system may remove or disregard the information of the preceding supporting actions.

The second aspect of the invention discloses a computer program product for scoring a profile in a social networking system comprising at least one Fan profile, at least one Talent profile and at least one Business profile, residing on a non-transitory processor-readable medium and comprising processor-readable instructions, which, when executed, cause a computer system to receive information of the at least one supporting action to at least one Talent profile a first Business profile has introduced to the social networking system; receive information of the at least one Talent profile which the Fan profile is assigned to; match the first Business profile that has supported the at least one Talent profile and the at least one Talent profile which the Fan profile is assigned to; and calculate based upon the information of at least one supporting action the score metrics representing the first Business profile's influence for the Fan profile.

The third aspect of the invention discloses a social networking system for scoring a profile comprising at least one Fan profile, at least one Talent profile and at least one Business profile, comprising a computer that has access to the social networking system, comprising at least one processor and memory storing instructions configured to instruct the at least one processor to receive information of the at least one supporting action to at least one Talent profile a first Business profile has introduced to the social networking system; receive information of the at least one Talent profile which the Fan profile is assigned to; match the first Business profile that has supported the at least one Talent profile and the at least one Talent profile which the Fan profile is assigned to; and calculate based upon the information of at least one supporting action the score metrics representing the first Business profile's influence for the Fan profile.

The embodiments of the invention described hereinbefore may be used in any combination with each other. Several of the embodiments may be combined together to form a further embodiment of the invention. A method, an apparatus, a system or a computer program product to which the invention is related may comprise at least one of the embodiments of the invention described hereinbefore. It is to be understood that any of the above embodiments or modifications can be applied singly or in combination to the respective aspects to which they refer, unless they are explicitly stated as excluding alternatives.

The present invention provides technical solutions that allow a Fan profile owner to find out the impact of the support an individual Business profile has on the same interests than the Fan profile owner. In other words the present invention allows the owner of the Fan profile to detect the most influential Business profiles that share his/her interests. The invention enables the scoring and ranking of several Business profiles from the Fan profile's point of view. The influence of the Business profile can be visualized to the user of the Fan profile. If a Brand or the related Business profile is ranked then a person can know the impact that the Brand has on his or her life. The Brand can show great value and importance to a person if it is highly ranked for a fan. For the Business profile owner this indication of measurable value and importance enhance the effect of sponsoring a Talent.

A brand will have the highest ranking for an individual if a Brand supports or sponsors the most athletes, musicians and artists that the individual is a fan of in a social networking system, for example the TeamUp. Traditional brand rankings tell how a brand ranks in the world and doesn't direct the ranking to a person's specific interests. A brand is worth more personally if it supports more of the talents and events that a person admires or participates in.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating an exemplary embodiment of the case where the first Fan, shares Talent's profile,

FIG. 2, is an exemplary illustration of the relationships between Fans, Talents and Businesses,

FIG. 3 is a table illustrating the Talents that the Fan has become a fan of, and

FIG. 4 is a table illustrating which Talents the Business is sponsoring,

FIG. 5 is a table illustrating how many years in addition to the current one that the Business has been a sponsor of the talent,

FIG. 6 is a table illustrating how many personal brand points a Business has based upon information from FIG. 5

FIG. 7 is a table illustrating how many personal brand points each business will receive for a fan based upon points from FIG. 6 and information from FIG. 3,

FIG. 8 shows the rank of each Business for each Fan based upon high points from FIG. 7 being number 1

FIG. 9 shows which Business Ranks 1-5 for each Fan based upon information from FIG. 8

### DETAILED DESCRIPTION OF THE INVENTION

Reference will now be made in detail to the exemplary embodiments of the present invention, examples of which are illustrated in the accompanying drawings.

A social network system is an online service, platform, or site that focuses on facilitating the building of social networks or social relations among people who, for example, share interests, activities, backgrounds or real-life connections. The social network system may reside on a computer that is connected to Internet or in a cloud computing environment. The social network system may comprise several interconnected computers.

The social network, social media or social network community comprises users with different roles or profiles. A profile may be considered in different roles in different contexts. According to the present invention, three profile types are introduced: a Fan, a Talent and a Business. At least two Talents form a Group. For this specification, the Fan or Fan profile already present in the social network community system is the first Fan and any new Fan or Fan profile is called the new Fan. A Talent, Business or Fan indicates a Talent profile, a Business profile or a Fan profile. This example does not limit the number of Fans in the social network or in the community. The community refers to the social network community system according to the present invention, comprising at least one interconnected Business, Talent and Fan profile. The social network service according to the present invention may comprise several interconnected Business, Talent or Fan profiles. The social network service may comprise a front page configured to be visualized as an Internet web page. The front page may comprise examples of Businesses or Talents and to indicate the reader of the web page some influential Businesses or Talents within the social network service.

Additional examples of social media community systems are described in patent applications U.S. Ser. No. 13/833,209 and U.S. Ser. No. 13/832,890; both of which are herein incorporated by reference.

Business profiles are linked to specific Brands, wherein the Brand is the name, term, design, symbol, or any other feature that identifies one seller's product distinct from those of other seller's. The present invention enables a Personal Brand Ranking, a way to know where a brand ranks as far as how much the brand supports or sponsors the things that are most important to him/her as an individual. Currently brands get ranked by many organizations for example by popularity, sustainability, value, customer satisfaction, but not for a specific person.

The Talent or Group profile may be part of the Business team profile. The Business Team refers to those profiles that are linked to the Business profile or receiving a sponsorship action executed by the Business profile. This enables a coordinated effort to market within a community. The invention takes into account actions and contributions made to a specific Talent or Group by providing a single point to link back to. The present invention provides a more refined scoring and ranking solution.

The Business profile's influence to the Fan profile is indicated primarily via the Talent profile. The Business receives visibility by being available in the Talent's page. The Talent profile's influence to the Business can be measured by the visibility to the Fans, new Fans joining the community or Fans purchasing items from the Talent or Business or joining the Business community. The Business can get a recognizable marketing effect and a direct contact with Fans by endorsing a Talent.

When illustrating the importance of the first Business profile or the related Brand for a Fan, factors that may be taken into account are for example, how much the first Business profile has supported the Talent, the duration of the supporting actions or the earliest supporting action. Based on collected information the system is configured to calculate ranking in relation to other Business profiles.

The Business, Talent or Group creates a profile within the social network community system. The Talent or Group may create a Talent shop and/or Sponsor Shop as part of the profile to sell items, experiences or sponsorship packages. The sponsorship package may comprise some visibility at the Talent profile's page, stickers attached to sports equipment or any other type of commitment to highlight the Business profile's brand in some way. A sponsorship agreement between the Talent can be made outside the social media community system, but it may be registered for example by a clickable button at the Talent profile's page or from the Business profile's page when the Talent has been selected. Another option is to send an invitation that indicates the sponsorship, wherein the other party registers the sponsorship by accepting the invitation. The first Fan also creates a profile to the social network community system, assigning to be a Fan of the Talent. The scoring information is saved in the database related to each profile, so the community may receive the information about the first Fan, Talent, Business or Business Team that have any related supporting actions. The database is connected to the social network community system.

In one exemplary embodiment the social network community system compiles the scores for Business profiles within the community. Communities are for example smaller networks within the wider social network system. The community may be based on the physical location, a city, country, common theme, music style, sport or alike. The community system is configured to rank the first Business in relation to the Fan based on a high score to low score. The highest score receives the ranking of 1. The Fan profile is able to see the ranking of all or portion of the Business profiles and detailed information of the activities that gave them that ranking. The social community system is configured to execute actions based on the ranking, for example the Business profile can send messages to those Fan profiles that have the Business profile on the top 15 ranking.

A User is defined in the social network community system as a person who has created at least one type of profile in the service according to the present invention: Fan profile, Business profile, or Talent profile. The user can create multiple profiles in the system. A unique identifier is used to differentiate the user. One example of unique identifier for the User_id is his email address.

A person who does not have a User_id in the system, is defined as a Visitor. A Visitor can be identified with e.g. web browser cookies.

The first Fan profile comprises at least a portion of the following information:
A Fan_id, which is the unique identifier of the first Fan
A User_id, which is the link to the user behind the profile
Name (e.g. “Kimmo Kivirauma”), picture, textual description, links to other web sites
Ids of other social media services (e.g. Facebook_id, Twitter_id, Googleplus_id) to get information such as how many followers the first Fan has, what are his latest posts, who are his Facebook friends etc.
A list of Talent ids that he is a Fan of, e.g. {Talent_id1, Talent_id2}
A list of Business Teams that he is a member of, e.g. {BT_id1, BT_id2}

The Talent profile comprises at least a portion of the following information:
A Talent_id, which is the unique identifier of a Talent
A User_id, which is the link to the user behind the profile
Name of the Talent (e.g. “John Smith”), picture, home town, country, textual description, links to the other web sites
A video identifier URL, (e.g. pointing to a Youtube URL)
Optional ids of other social media services (e.g. Facebook_id, Twitter_id, Googleplus_id) to get information such as how many Likes the Talent has in Facebook, how many followers the Talent has, what are his latest tweets, etc.
A list of the first Fan ids that are his Fans, e.g. {Fan_id1, Fan_id2}
A list of Talent ids that he is the first Fan of, e.g. {Talent_id1, Talent_id2}. The Talent can be the first Fan of other Talents as well.
A list of Business ids, that are supporting the Talent, e.g. {Busn_id1, Busn_id2}
A list of Business Teams that the Talent is a member of, e.g. {BT_id1, BT_id2}
A list/table which shows all the Businesses that are related to Talents which the Fan profile is assigned as a fan of. E.g. {(Fan_id443, 10500), (Fan_id30, 9500), (Fan_id33, 8000), . . . (Fan_id604, 1)}. This list/table can be ordered so that the first one is always the one with the highest score. Thus, individual Business's ranking related to this Talent can easily be illustrated by his position in the ordered list.

The first Business profile comprises at least a portion of the following information:
A Business_id, which is the unique identifier of the first Business
A User_id, which is the link to the user behind the profile
Name (e.g. “TeamUp”), picture, textual description, links to other web sites
A list of Talent ids that the Business profile supports, e.g. {Talent_id1, Talent_id2}
A list/table which shows the points earned related to each Talent, e.g. {(Talent_id1, 100), (Talent_id2, 150)}

In one example the Talent profile is assigned as the shopkeeper to a Fan shop or to a Business shop, which consists of items for sale. Items in the shop have Shop_item_id, picture, description, price (either actual price with or without the VAT, or “ask for pricing”), availability (how many items available/out_of_stock), availability_until_date. In the case of Business shop, an item can also have a sponsor_me_to_your_team_flag, that may be used to purchase sponsorships or sponsor items.

The points table is assigned to Points_table in the social network community system. The system comprises a table which lists how many points are related to different actions and to which profile.

An exemplary embodiment is described herein to illustrate the scoring. The first Fan profile Fan1 assigns to be a Fan of Talent1, Talent2, Talent3, Talent4 and Talent5. The second Fan profile Fan2 assigns to be a Fan of Talent1, Talent3, Talent4, Talent6 and Talent7.

The first Business profile Business1 supports or sponsors Talent1, Talent4 and Talent7. The second Business profile Business2 supports or sponsors Talent2, Talent6 and Talent7 The third Business profile Business3 supports or sponsors Talent1, Talent2, Talent3 and Talent5.

Points are distributed in this example as follows: 1 point for each talent the Business supports that the Fan is assigned as a fan of

For the first Fan profile Fan1:

### Points for Business1 is 2;

### Points for Business2 is 1; and

### Points for Business3 is 4

The Business profiles are ranked by which has the most points. Therefore, for the first Fan profile Fan1 the Businesses are ranked as follows:

Business3 is number 1 with 4 points
Business1 is number 2 with 2 points
Business2 is number 3 with 1 point.
For the second Fan profile Fan2:

### Points for Business1 is 3;

### Points for Business2 is 2; and

### Points for Business3 is 2.

Therefore, for the second Fan profile Fan2 the personal brand ranking is as follows:

Business1 is number 1; and
Business2 and Business3 are tied for number 2.

Business profiles can receive more points based upon the length of time they are sponsoring the Talent profile. In this example the above calculations may be used but instead value 0.5 will be added for each year the Business profile has been sponsoring in addition to the current year. Also other values and/or time periods may be used. For example:

The first Business profile, Business1, sponsors Talent1 and this is the first year of sponsorship. A one point is given for personal brand points from the first Fan, Fan1, when the first Fan becomes a fan of Talent1.

The second Business profile, Business2, sponsors Talent1 and this is the second year of sponsoring that Talent. When the first Fan profile, Fan1, becomes a Fan of Talent1 then the second Business profile receives 1.5 personal brand points from the first Fan profile Fan1.

The third Business profile Business3 sponsors Talent1 and this is the fifth year of sponsoring that Talent so the points are 2.5. This encourages long term sponsorships by Business profiles for a particular talent. Business profiles will retain points as long as they are a current sponsor of the talent. Once sponsorship is removed then no points will be given to the Business profile.

A list or table will store the points the Business profile is entitled to for each talent in the social network system in the following manner: Talent profiles that the Business profile does not support will not be in the table as the point value will be null. One point is given for being a current year sponsor and a half of a point is given for each of prior year sponsorships. The point value given could be more or less than what is indicated in this example.

Finally, a calculation will be made for each Fan where personal brand points will be designated for each Business profile based upon the points granted for each Talent from List A that the Business profile supports that the Fan is a Fan of and the Business has value greater than null. For example:

### {(Fan_id1,Bus_id5,1), (Fan_id1, Bus_id6,3), (Fan_id1,Bus_id7,2) . . . }

The personal brand ranking will be displayed in the profile page of the Fan with the Business profile or the related brand with the highest number of points being first followed by the next highest Business profile and so on. The ranking can be displayed in a list view and number or visually as a map or other diagram or drawing.

Other criteria for gaining personal brand points for a Business profile are based upon how much financial support they give to a Talent. Extra points will be given based upon the total amount of the support. One example of such calculation is that a Business supports a Talent with less than 1000 dollars, resulting to multiplying the total points by 1. If the amount supported is more than 1000 dollars but less than 5000 dollars then the points are multiplied by 1.5. If the total support is more than 5,000 dollars but less than 10,000 dollars then the points are multiplied by 2. For supporting actions in excess of 10,000 dollars the points are multiplied by 3.

Other criteria for gaining personal brand points for a Business profile are based on offers made to the Fan in the service and the Fan accepts such an offer. An example of such an offer could be that the Business invites the Fan to a free or discounted Business supported event of the talent, offers a discount on a Talent shop item or a Business shop item, or if the Fan accepts any other Business promotion offered in the service. The business could gain for example 5 brand points for each such occurrence.

A list or table is configured to store the total in sponsorship and/or support by each Business for each Talent. As each sponsorship deal is made the total value will be stored and summed for example for a period of one year. The previous year's total will be used as the multiplier for the current year. As an example, all values would be multiplied by the appropriate factor based upon the total support or sponsorship.

Sponsorship totals will be kept on an annual basis and the points earned for that year will be multiplied by the appropriate factor.

An exemplary embodiment of the social media community is illustrated in FIG. 1. Screen illustration 101 exemplifies the web page of Talent profile named Talent A within the social media community. The web page comprises a clickable button 102 for any user of the community to be assigned as a Fan of Talent A. In this example Talent A has a Fan called Kimmo, as illustrated in box 103.

Talent A has a Fan shop 104 comprising different items for sale. These available items may change according to the profile used to view the Talent profile. For example the Fan shop may comprise traditional Fan merchandise, such as shirts and caps. For the Business profile 105 the Talent shop is shown as Business shop with additional items such as sponsorship packages. For example the Business profile may purchase one year's visibility with the Talent or the Talent profile. For the social media community all Talent profiles supporters or sponsors are shown, as in this example also the second Business profile 106.

FIG. 2 is a map diagram illustrating a Fan and the Talents he is connected to in the social media community along with the Businesses that are connected to each of those talents because of sponsorship, along with the personal branding points given to that Business based upon years the Business has sponsored that Talent and finally how the Businesses would rank after the points are summed for each Talent they are supporting for that Fan. Different Business profiles are denoted with B1, B2, B3; Talent profiles are denoted with T1, T4, T6; and the Fan profile in the center is denoted with F1. Different point scoring structures are accumulated according to predefined rules. For example considering Talent T1, the Businesses B1, B2 and B4 have different points as a result of different duration of sponsoring or different monetary values invested in the sponsorship. The result of ranking is illustrated in the top row, wherein business profiles have been scored and ranked. In this example the third Business profile B3 or the related Brand is ranked first; whereas the fifth Business profile or the related Brand is ranked fifth.

FIG. 3 is a table illustrating an example of relationships between Fan profiles and Talent profiles. An “x” indicates a relationship. Rows indicate Talent profiles in the social media community system. Columns are the Fan profiles in the social media community system. When a Fan profile becomes a Fan of a Talent an “X” is marked. A “NULL” value means there is no Fan-Talent relationship.

FIG. 4 is another table illustrating an example of relationships between Business profiles and Talent profiles. An “x” indicates a relationship. Rows indicate Talent profiles in the social media community system. Columns are the Business profiles in the social media community system. When a Business profile becomes a sponsor of a Talent an “X” is marked. A “NULL” value means there is no Business-Talent relationship such as sponsoring.

FIG. 5 is another table illustrating an example of relationships between Business profiles and Talent profiles, wherein the number of years of sponsorship is included. Rows indicate Talent profiles and columns indicate Business profiles. The entry of 1 means that the Business profile is a current year sponsor. Null value means the Brand is not a current sponsor. Values higher than one indicate how many years the Business profile has been a sponsor in addition to the current year. For example a value of 2 means the Business profile is a current sponsor and also have one prior year as a sponsor.

FIG. 6 is another table illustrating another embodiment of the value of sponsoring years. The entry is calculated from the table of FIG. 5, wherein the value received is calculated by 1+x/2, where x is the corresponding position is FIG. 5. If the value in FIG. 5 is null, then the corresponding value in FIG. 6 is also null value.

FIG. 7 is an exemplary table illustrating total personal brand points that a Business profile has with each Fan. It is calculated by summing the points from table in FIG. 6 for each Business profile based upon which Talents the Fan is a fan of from FIG. 3 and the Business profile is a sponsor for from FIG. 4. For example Fan_id1 is a Fan of Talents 1,4,6,8, and 9 from FIG. 3. Bus_id1 sponsors only 1, 6, and 9 of those from FIG. 4, so the personal brand points come from only Talent profiles 1,6, and 9. Going to FIG. 6 means that personal brand points would be 1+1+2 which is a total of 4. Therefore an entry of 4 is written for Fan_id1 with Bus_id1.

FIG. 8 illustrates one example of the personal Brand ranking. The brand or the related Business profile is given a Rank of 1, In the case of a tie two or more profiles share the rank. FIG. 9 illustrates the Brands or related Business profiles that rank 1,2,3, . . . for each Fan. In this example For Fan_id1 Bus_id3 is the highest ranking personal brand, but for Fan_id4 Bus_id4 is the highest ranking brand. All tables presented in this description are examples of the database or data structures that enable the invention.

Embodiments of the present invention may be implemented in software, hardware, application logic or a combination of software, hardware and application logic. In an example embodiment, the application logic, software or instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer. The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

If desired, the different functions discussed herein may be performed in a different order and/or concurrently with each other.

Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

It is obvious to a person skilled in the art that with the advancement of technology, the basic idea of the invention may be implemented in various ways. The invention and its embodiments are thus not limited to the examples described above; instead they may vary within the scope of the claims.

1. A method for scoring a Business profile in a social networking system comprising at least one Fan profile, at least one Talent profile and at least one Business profile, comprising a computer that has access to the social networking system and is configured to:
receive information of the at least one supporting action to at least one Talent profile a first Business profile has introduced to the social networking system;
receive information of the at least one Talent profile which the Fan profile is assigned to; and
match the first Business profile that has supported the at least one Talent profile and the at least one Talent profile which the Fan profile is assigned to; and
calculate based upon the information of at least one supporting action the score metrics representing the first Business profile's influence for the Fan profile.

2. The method according to claim 1, wherein information of the supporting action comprises the number of the first Business profile's purchases from the at least one Talent profile's shop.

3. The method according to claim 1, wherein information of the supporting action comprises the value of the first Business profile's purchases from the at least one Talent profile's shop.

4. The method according to claim 1, wherein information of the supporting action comprises the time elapsed from the purchase the first Business profile has completed from the at least one Talent profile's shop.

5. The method according to claim 1, wherein information of preceding supporting action is removed from the social networking system after a predetermined time period when the first Business profile is not executing a supporting action.

6. The method according to claim 1, wherein the computer is configured to rank the at least one Business profile based on the score metrics in relation to the Fan profile.

7. A computer program product for scoring a profile in a social networking system comprising at least one Fan profile, at least one Talent profile and at least one Business profile, residing on a non-transitory processor-readable medium and comprising processor-readable instructions, which, when executed, cause a computer system to:
receive information of the at least one supporting action to at least one Talent profile a first Business profile has introduced to the social networking system;
receive information of the at least one Talent profile which the Fan profile is assigned to; and
match the first Business profile that has supported the at least one Talent profile and the at least one Talent profile which the Fan profile is assigned to; and
calculate based upon the information of at least one supporting action the score metrics representing the first Business profile's influence for the Fan profile.

8. The computer program product according to claim 7, wherein information of the supporting action comprises the number of the first Business profile's purchases from the at least one Talent profile's shop.

9. The computer program product according to claim 7, wherein information of the supporting action comprises the value of the first Business profile's purchases from the at least one Talent profile's shop.

10. The computer program product according to claim 7, wherein information of the supporting action comprises the time elapsed from the purchase the first Business profile has completed from the at least one Talent profile's shop.

11. The computer program product according to claim 7, wherein information of preceding supporting action is removed from the social networking system after a predetermined time period when the first Business profile is not executing a supporting action.

12. The computer program product according to claim 7, causing a computer system to rank the at least one Business profile based on the score metrics in relation to the Fan profile.

13. A social networking system for scoring a profile comprising at least one Fan profile, at least one Talent profile and at least one Business profile, comprising a computer that has access to the social networking system, comprising at least one processor and memory storing instructions configured to instruct the at least one processor to:
receive information of the at least one supporting action to at least one Talent profile a first Business profile has introduced to the social networking system;
receive information of the at least one Talent profile which the Fan profile is assigned to; and
match the first Business profile that has supported the at least one Talent profile and the at least one Talent profile which the Fan profile is assigned to; and
calculate based upon the information of at least one supporting action the score metrics representing the first Business profile's influence for the Fan profile.

14. The system according to claim 13, wherein information of the supporting action comprises the number of the first Business profile's purchases from the at least one Talent profile's shop.

15. The system according to claim 13, wherein information of the supporting action comprises the value of the first Business profile's purchases from the at least one Talent profile's shop.

16. The system according to claim 13, wherein information of the supporting action comprises the time elapsed from the purchase the first Business profile has completed from the at least one Talent profile's shop.

17. The system according to claim 13, wherein information of preceding supporting action is removed from the social networking system after a predetermined time period when the first Business profile is not executing a supporting action.

18. The system according to claim 13, wherein the computer is configured to rank the at least one Business profile based on the score metrics in relation to the Fan profile.
